(19) United States
(12) Patent Application Publication
(10) Pub. No.: US 2017/0111224 A1
(43) Pub. Date: Apr. 20, 2017

(54) MANAGING COMPONENT CHANGES FOR IMPROVED NODE PERFORMANCE

(71) Applicant: Lenovo Enterprise Solutions (Singapore) Pte. Ltd., Singapore (SG)

(72) Inventors: James S. Worley, Raleigh, NC (US); Srihari V. Angaluri, Raleigh, NC (US); Gary D. Cudak, Wake Forest, NC (US); Chulho Kim, Poughkeepsie, NY (US); Makoto Ono, Chapel Hill, NC (US)

(21) Appl. No.: 14/884,283

(22) Filed: Oct. 15, 2015

(51) Int. Cl. H04L 12/24; H04L 12/26

(52) U.S. Cl. CPC H04L 41/0853; H04L 41/082; H04L 43/10

(57) ABSTRACT

A method includes maintaining a component inventory history identifying components installed in each of a plurality of compute nodes over time, wherein the components are selected from hardware, firmware, drivers, and software. The method further includes monitoring performance of each compute node, identifying changes in the components installed in the compute nodes, and, for each identified change in the components, quantifying a difference in the performance of the compute node after the change in the components relative to the performance of the compute node before the change in the components. Still further, the method includes associating each identified change in the components of the compute node with the difference in the performance of the compute node, and calculating a measure of performance change that is associated with a particular component change for a group of the compute nodes having a predetermined similarity of components.

### BACKGROUND

Field of the Invention

The present invention relates to methods of managing the performance of compute nodes.

Background of the Related Art

A datacenter may include a large number of compute nodes, such as servers, that are managed by a management node. The management node may be responsible for allocating workload to the individual compute nodes and detecting errors and failures associated with the compute nodes. Each compute node may have its own configuration of components, whether its unique configuration was optimized for a given task or was simply the result of various component replacements and upgrades over time. Furthermore, software, firmware and drivers may be occasionally updated, although such processes may be interrupted or prevented as to certain compute nodes by other processes or maintenance activities affecting those nodes. Accordingly, the compute nodes in a given computer system may have certain similarities and certain differences in both hardware components and software components. These similarities and differences may change over time as additional hardware and software changes are made to the compute nodes.

### BRIEF SUMMARY

One embodiment of the present invention provides a method, comprising maintaining a component inventory history identifying components installed in each of a plurality of compute nodes over time, wherein the components are selected from hardware, firmware, drivers, and software. The method further comprises monitoring performance of each of the compute nodes, identifying changes in the components installed in the plurality of compute nodes, and, for each identified change in the components installed in one of the plurality of compute nodes, quantifying a difference in the performance of the compute node after the change in the components relative to the performance of the compute node before the change in the components. Still further, the method comprises associating each identified change in the components of the compute node with the difference in the performance of the compute node, and calculating a measure of performance change that is associated with a particular component change for a group of the compute nodes having a predetermined similarity of components.

Another embodiment of the present invention provides a computer program product comprising a non-transitory computer readable storage medium having program instructions embodied therewith, wherein the program instructions are executable by a processor to cause the processor to perform a method. The method comprises maintaining a component inventory history identifying components installed in each of a plurality of compute nodes over time, wherein the components are selected from hardware, firmware, drivers, and software. The method further comprises monitoring performance of each of the compute nodes, identifying changes in the components installed in the plurality of compute nodes, and, for each identified change in the components installed in one of the plurality of compute nodes, quantifying a difference in the performance of the compute node after the change in the components relative to the performance of the compute node before the change in the components. Still further, the method comprises associating each identified change in the components of the compute node with the difference in the performance of the compute node, and calculating a measure of performance change that is associated with a particular component change for a group of the compute nodes having a predetermined similarity of components.

### BRIEF DESCRIPTION OF THE SEVERAL VIEWS OF THE DRAWINGS

FIG. 1 is a diagram of a system including a plurality of compute nodes coupled to a management node.

FIG. 2 is a diagram of a node that is representative of the compute nodes and the management node capable of implementing the methods of the present invention.

FIG. 3 is a flowchart of a method according to one embodiment of the present invention.

### DETAILED DESCRIPTION

One embodiment of the present invention provides a method, comprising maintaining a component inventory history identifying components installed in each of a plurality of compute nodes over time, wherein the components are selected from hardware, firmware, drivers, and software. The method further comprises monitoring performance of each of the compute nodes, identifying changes in the components installed in the plurality of compute nodes, and, for each identified change in the components installed in one of the plurality of compute nodes, quantifying a difference in the performance of the compute node after the change in the components relative to the performance of the compute node before the change in the components. Still further, the method comprises associating each identified change in the components of the compute node with the difference in the performance of the compute node, and calculating a measure of performance change that is associated with a particular component change for a group of the compute nodes having a predetermined similarity of components.

The component inventory history may be maintained on any one of the plurality of compute nodes designated as a management node or, more preferably, on a dedicated management node that is in communication with the plurality of compute nodes and is responsible for other management functions relative to the plurality of compute nodes. The component inventory history identifies components installed in each of the compute nodes over time. For example, the component inventory history may identify, for each of the compute nodes, an original set of components and a component change history that details what new component replaced what old component. Optionally, the component inventory history may focus on a limited subset of all components of a compute node, such as those components that are expected to have the greatest impact on the performance of the compute nodes. For example, the method may be restricted to only identify changes in the components within the limited subset of components that are expected to have the greatest impact on the performance of the compute nodes.

In a specific example, the components tracked by the component inventory history are selected from operating system version, operating system patch version, CPU version, CPU Clock speed, memory version, memory bus speed, network adapter version, network adapter firmware version, network adapter driver version, storage adapter, storage adapter firmware version, storage adapter driver version, and UEFI settings. Optionally, the component inventory may include a component version, model number, capacity or speed for each of the identified components.

The performance of each compute node may be monitored continuously or periodically, and may include any one or more performance metric. Furthermore, the performance of a compute node may be monitored by a management node, or monitored by the compute node itself and reported to the management node. In one non-limiting option, at least one performance parameter of each of the compute nodes is monitored, wherein the at least one performance parameter is selected from CPU cache performance, system memory throughput, network adapter latency, network adapter throughput, data storage latency, data storage input/output rates, and combinations thereof.

Incremental changes in the components installed in the plurality of compute nodes may be initially identified by a service processor, such as a baseboard management controller (BMC), on individual compute nodes where the component is installed. For example, on any given compute node, a baseboard management controller may read and store the vital product data of installed components. When the baseboard management controller reads vital product data of an installed component and that vital product data does not match the stored vital product data, then the baseboard management controller has identified a change in the components on that compute node. The baseboard management controller may then, or at a later point in time, report the change in components to a management node.

For each identified change in the components installed in one of the plurality of compute nodes, the method quantifies a difference in the performance of the compute node after the change in the components relative to the performance of the compute node before the change in the components. The difference may be quantified by the compute node that is the subject of the component change, or by a management node that receives performance data from the compute node representing performance before and after installation of the new component. It should be recognized that not all component changes are beneficial, such that the quantified difference in the performance may either an increase in performance or a decrease in performance.

Each identified change in the components of the compute node is associated with the difference in the performance of the compute node. The method may then calculate a measure of performance change that is associated with a particular component change for a group of the compute nodes having a predetermined similarity of components. For example, the method may calculate a measure of performance change as the average performance change associated with updating firmware to the latest version for a group of the compute nodes having the same processor model number and the same amount of memory. Similarly, the method may calculate a measure of performance change that is associated with a particular component change for a group of the compute nodes having a predetermined similarity of components and a predetermined similarity in workload. For example, the method may calculate a measure of performance change as the average performance change associated with updating firmware to the latest version for a group of the compute nodes having the same processor model number and the same amount of memory, as well as running the same type of workloads. It should be understood that implementing the present invention in a system with a large number of compute nodes will result in a larger data set of component changes and associated differences in performance, such that a measure of performance change may be determined for compute nodes having a greater degree of similarity.

In various embodiments, one or more steps of the method may be performed by a management node, such as a management server, in communication with the plurality of compute nodes. For example, each compute node may report component changes and performance parameters to the management node, wherein the management node quantifies the differences in the performance of the compute nodes associated with the component changes. In one option, each compute node may report the component changes and performance parameters to the management node in response to each change in one or more of the components, such as after detecting the component change and measuring a new value of a performance parameter.

In a further embodiment, the management node may recommend a change in one or more component of another compute node to achieve the associated increase in performance. For example, the method may identify a target compute node having the same components as one or more of the compute nodes in the component inventory, and recommend a component change for the target compute node to achieve the associated increase in performance. Optionally, the recommended component change for the target compute node may be automatically implemented, such as where the recommended component change is selected from a change in firmware version, a change in driver version, and a change in a software application version.

In a still further embodiment, component and performance data for a particular workload may be stored each time the particular workload is run on one of the plurality of compute nodes. In this manner, the workload is the same and the performance across a number of compute nodes with different component can be used to determine how differences in components affect a different in performance. Accordingly, the method may identify a target set of components that result in greater performance of the particular workload. In one option, a subsequent instance of the particular workload may be assigned to one of the compute nodes having the target set of components. In another option, one or more components of a target compute node may be automatically changed to include the target set of components prior to assigning a subsequent instance of the particular workload to the target compute node.

Another embodiment of the present invention provides a computer program product comprising a non-transitory computer readable storage medium having program instructions embodied therewith, wherein the program instructions are executable by a processor to cause the processor to perform a method. The method comprises maintaining a component inventory history identifying components installed in each of a plurality of compute nodes over time, wherein the components are selected from hardware, firmware, drivers, and software. The method further comprises monitoring performance of each of the compute nodes, identifying changes in the components installed in the plurality of compute nodes, and, for each identified change in the components installed in one of the plurality of compute nodes, quantifying a difference in the performance of the compute node after the change in the components relative to the performance of the compute node before the change in the components. Still further, the method comprises associating each identified change in the components of the compute node with the difference in the performance of the compute node, and calculating a measure of performance change that is associated with a particular component change for a group of the compute nodes having a predetermined similarity of components.

The foregoing computer program products may further include computer readable program code for implementing or initiating any one or more aspects of the methods described herein. Accordingly, a separate description of the methods will not be duplicated in the context of a computer program product.

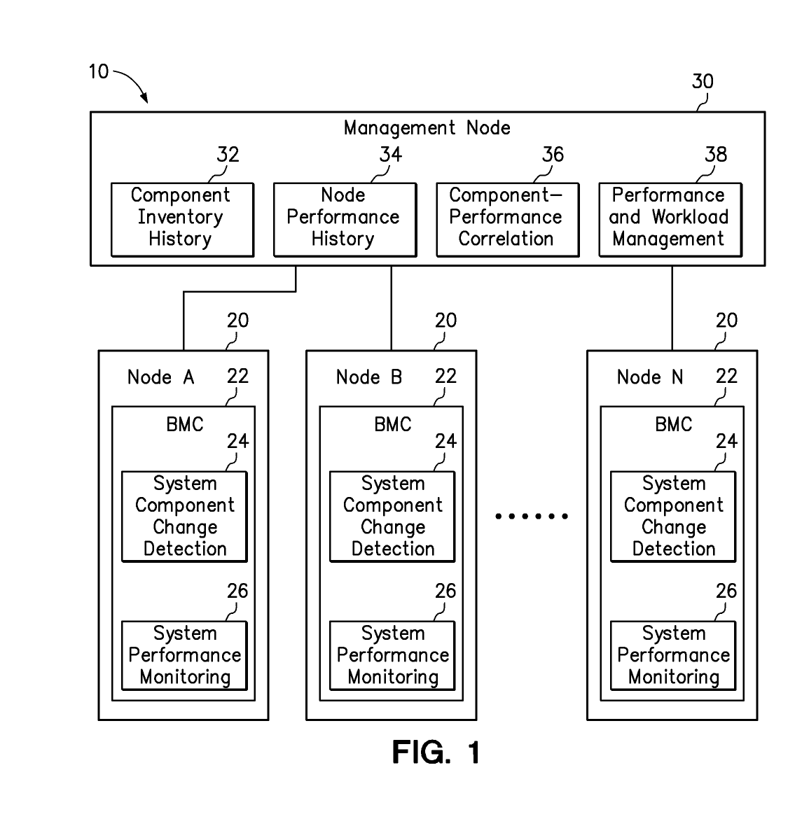

FIG. 1 is a diagram of a system 10 including a plurality of compute nodes 20 coupled to a management node 30. The system may include any number of computer nodes 20 and each of the compute nodes 20 may have different combinations of components, including different models, versions, updates, speeds and capacities of components. While each of the compute nodes 20 may have different system components, the compute nodes 20 are shown including the same logic elements that may be used to implement embodiments of the present invention. Accordingly, each compute node 20 has a baseboard management controller (BMC) 22 that monitors the system components of the node and runs various processes, including a system component change detection module 24 and a system performance monitoring module 26. Both of the modules 24, 26 may take the form of software code executable by the baseboard management controller 22.

The management node 30 may be a server that is dedicated to managing the plurality of compute nodes 20 and is in communication, directly or indirectly with each of the plurality of compute nodes 20. For purposes of implementing one or more embodiment of the present invention, the management node 30 is shown to include various logic elements that may be implemented as software. Specifically, the management node 30 in this example includes a component inventory history module 32, a node performance history module 34, a component-performance correlation/association module 36, and a performance and workload management module 38. The component inventory history module 32 includes logic for receiving and maintaining a history of components (i.e., inventory) that are installed in each of the compute nodes 20. The history may therefore document a plurality of component combinations present in a given node over time as incremental changes are made to the node. The node performance history module 34 includes node performance data over time, preferably including at least one measure of node performance for each configuration of the node (i.e., before and after each incremental change in the components of the node). The component-performance correlation/association module 36 includes data that associates each component change with a performance change. As previously described, such associations may optionally be separately determined and maintained for compute nodes having one or more predetermined similarities. For example, a change in a firmware version may result in a first performance change in a first node having processor with a first speed and a first memory capacity, whereas the same change in a firmware version may result in a second (higher or lower) performance change in a second node having processor with a second speed and a second memory capacity. The performance and workload management module 38 includes logic for monitoring the performance of each compute node and managing workload across the plurality of compute nodes 20. For example, the management node may recommend and/or implement a component change for a target compute node in order to increase performance of a workload that has been, or will soon be, allocated to the target compute node. Conversely, the management node may recommend against a component change that has been found to cause a decline in performance.

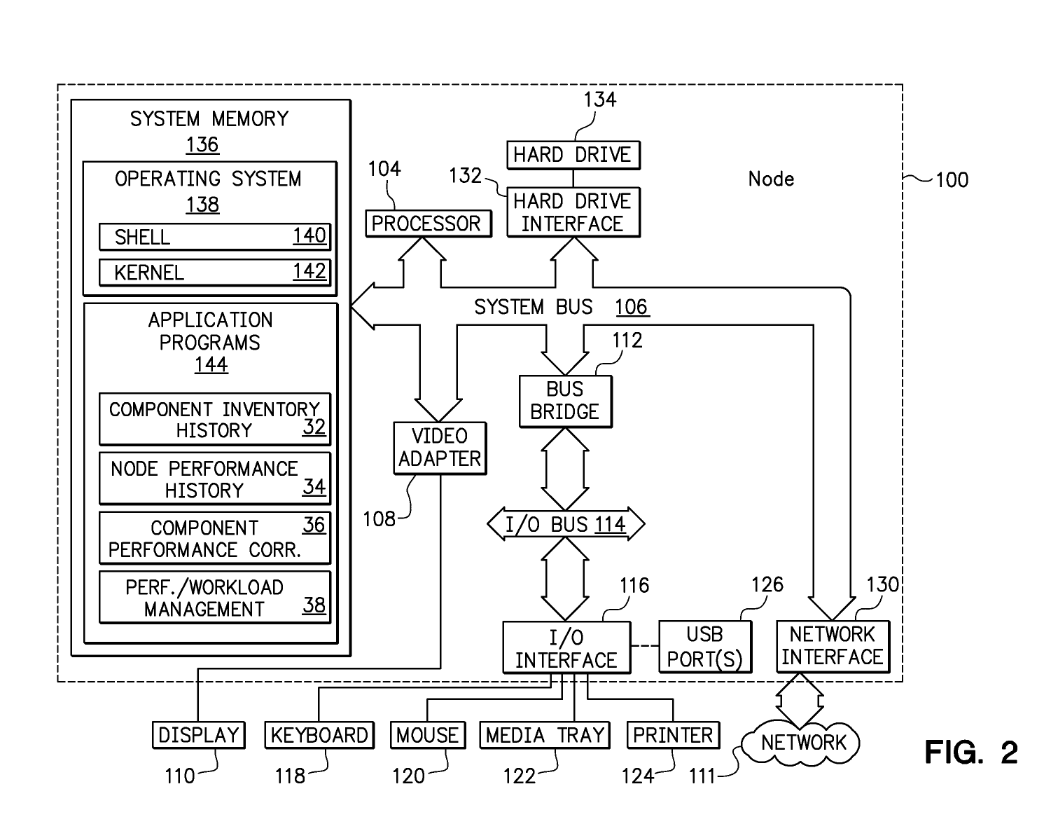

FIG. 2 is a diagram of a node 100 that may be representative of the compute nodes 20 and the management node 30 capable of implementing the methods of the present invention. The computer 100 includes a processor unit 104 that is coupled to a system bus 106. The processor unit 104 may utilize one or more processors, each of which has one or more processor cores. A video adapter 108, which drives/supports a display 110, is also coupled to system bus 106. The system bus 106 is coupled via a bus bridge 112 to an input/output (I/O) bus 114. An I/O interface 116 is coupled to the I/O bus 114. The I/O interface 116 affords communication with various I/O devices, including a keyboard 118, a mouse 120, a media tray 122 (which may include storage devices such as CD-ROM drives, multi-media interfaces, etc.), a printer 124, and USB port(s) 126. As depicted, the computer 100 is able to communicate with other network devices via the network 111 using a network adapter or network interface controller 130.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as a lowest level of volatile memory in the computer 100. This volatile memory includes additional higher levels of volatile memory (not shown), including, but not limited to, cache memory, registers and buffers. Data that populates the system memory 136 includes the operating system (OS) 138 and application programs 144.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 is a text-based, line-oriented user interface, the present invention will equally well support other user interface modes, such as graphical, voice, gestural, etc.

As depicted, the operating system 138 also includes the kernel 142, which includes lower levels of functionality for the operating system 138, including providing essential services required by other parts of the operating system 138 and application programs 144, including memory management, process and task management, disk management, and mouse and keyboard management. As shown, the computer 100 includes application programs 144 in the system memory of the computer 100 as may be utilized by the management node 30 of FIG. 1, including, without limitation, the component inventory history module 32, the node performance history module 34, the component-performance correlation/association module 36, and the performance and workload management module 38. Where the node 100 is configured as a compute node, the application programs 144 may include, without limitation, a system component change detection module 24 and a system performance monitoring module 26 as shown in FIG. 1.

The hardware elements depicted in the computer 100 are not intended to be exhaustive, but rather are representative. For instance, the computer 100 may include alternate memory storage devices such as magnetic cassettes, digital versatile disks (DVDs), Bernoulli cartridges, and the like. These and other variations are intended to be within the scope of the present invention.

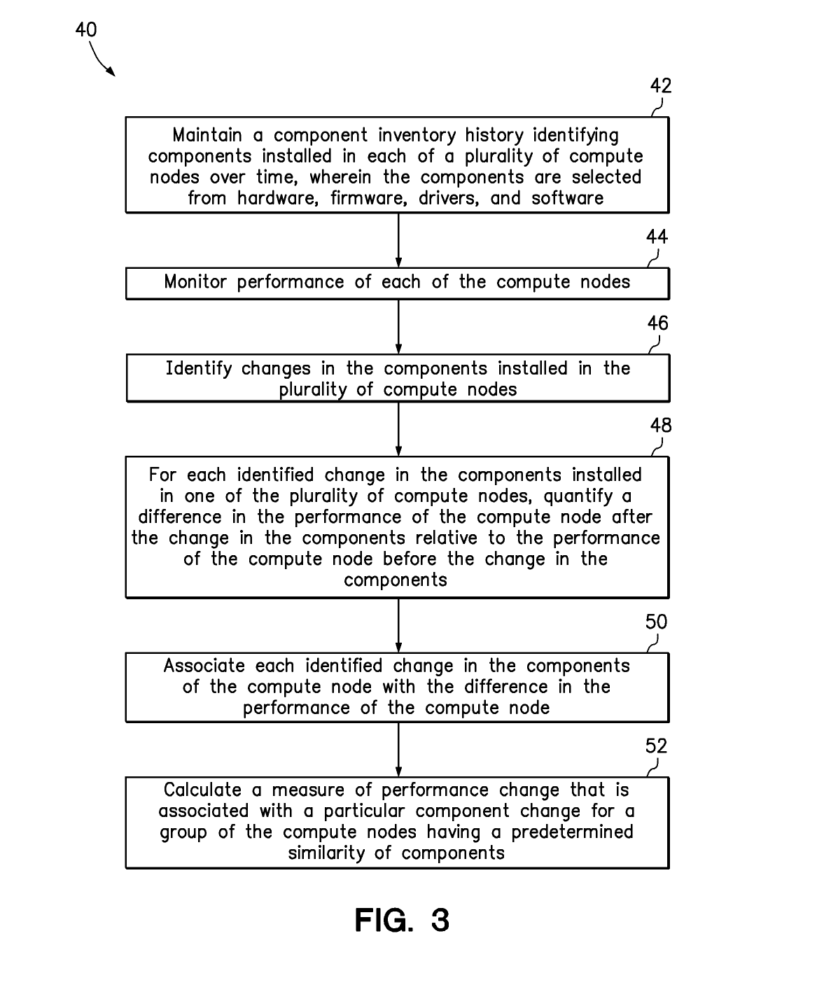

FIG. 3 is a flowchart of a method 40 according to one embodiment of the present invention. In step 42, the method maintains a component inventory history identifying components installed in each of a plurality of compute nodes over time, wherein the components are selected from hardware, firmware, drivers, and software. The method then monitors performance of each of the compute nodes in step 44, and identifies changes in the components installed in the plurality of compute nodes in step 46. In step 48, the method includes, for each identified change in the components installed in one of the plurality of compute nodes, quantifying a difference in the performance of the compute node after the change in the components relative to the performance of the compute node before the change in the components. Each identified change in the components of the compute node is associated with the difference in the performance of the compute node in step 50 and a measure of performance change that is associated with a particular component change is calculated for a group of the compute nodes having a predetermined similarity of components in step 52.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
maintaining a component inventory history identifying components installed in each of a plurality of compute nodes over time, wherein the components are selected from hardware, firmware, drivers, and software;
monitoring performance of each of the compute nodes;
identifying changes in the components installed in the plurality of compute nodes;
for each identified change in the components installed in one of the plurality of compute nodes, quantifying a difference in the performance of the compute node after the change in the components relative to the performance of the compute node before the change in the components;
associating each identified change in the components of the compute node with the difference in the performance of the compute node; and
calculating a measure of performance change that is associated with a particular component change for a group of the compute nodes having a predetermined similarity of components.

2. The method of claim 1, wherein the components are selected from operating system version, operating system patch version, CPU version, CPU Clock speed, memory version, memory bus speed, network adapter version, network adapter firmware version, network adapter driver version, storage adapter, storage adapter firmware version, storage adapter driver version, and UEFI settings.

3. The method of claim 1, wherein monitoring performance of each of the compute nodes includes monitoring at least one performance parameter of each of the compute nodes, wherein the at least one performance parameter is selected from CPU cache performance, system memory throughput, network adapter latency, network adapter throughput, data storage latency, data storage input/output rates, and combinations thereof.

4. The method of claim 1, wherein the quantified difference in the performance includes both increases in performance and decreases in performance.

5. The method of claim 1, wherein the component inventory includes a component version, model number, capacity or speed for each of the identified components.

6. The method of claim 1, further comprising:
each compute node reporting component changes and performance parameters to a management node, wherein the management node quantifies the differences in the performance of the compute nodes associated with the component changes.

7. The method of claim 6, wherein each compute node reports the component changes and performance parameters to the management node in response to each change in one or more of the components.

8. The method of claim 6, further comprising:
the management node recommending a change in one or more component of another compute node to achieve the associated increase in performance.

9. The method of claim 1, further comprising:
identifying a target compute node having the same components as one or more of the compute nodes in the component inventory; and
recommending a component change for the target compute node to achieve the associated increase in performance.

10. The method of claim 9, further comprising:
automatically implementing the recommended component change for the target compute node, wherein the recommended component change is selected from a change in firmware version, a change in driver version, and a change in a software application version.

11. The method of claim 1, wherein calculating a measure of performance change that is associated with a particular component change for a group of the compute nodes having a predetermined similarity of components includes calculating a measure of performance change that is associated with a particular component change for a group of the compute nodes having a predetermined similarity of components and a predetermined similarity in workload.

12. The method of claim 1, further comprising:
identifying a target compute node having the predetermined similarity in the inventory of components and the predetermined similarity in workload as one or more of the compute nodes in the component inventory; and
recommending a component change for the target compute node to achieve the associated increase in performance.

13. The method of claim 1, further comprising:
storing component and performance data for a particular workload each time the particular workload is run on one of the plurality of compute nodes;
identifying a target set of components that result in greater performance of the particular workload; and
assigning a subsequent instance of the particular workload to one of the compute nodes having the target set of components.

14. The method of claim 1, further comprising:
storing component and performance data for a particular workload each time the particular workload is run on one of the plurality of compute nodes;
identifying a target set of components that result in greater performance of the particular workload; and
automatically changing one or more components of a target compute node to include the target set of components prior to assigning a subsequent instance of the particular workload to the target compute node.

15. A computer program product comprising a non-transitory computer readable storage medium having program instructions embodied therewith, the program instructions executable by a processor to cause the processor to perform a method comprising:
maintaining a component inventory history identifying components installed in each of a plurality of compute nodes over time, wherein the components are selected from hardware, firmware, drivers, and software;
monitoring performance of each of the compute nodes;
identifying changes in the components installed in the plurality of compute nodes;
for each identified change in the components installed in one of the plurality of compute nodes, quantifying a difference in the performance of the compute node after the change in the components relative to the performance of the compute node before the change in the components;
associating each identified change in the components of the compute node with the difference in the performance of the compute node; and
calculating a measure of performance change that is associated with a particular component change for a group of the compute nodes having a predetermined similarity of components.

16. The computer program product of claim 15, further comprising:
each compute node reporting component changes and performance parameters to a management node, wherein the management node quantifies the differences in the performance of the compute nodes associated with the component changes.

17. The computer program product of claim 16, wherein each compute node reports the component changes and performance parameters to the management node in response to each change in one or more of the components.

18. The computer program product of claim 15, further comprising:
identifying a target compute node having the same components as one or more of the compute nodes in the component inventory; and
recommending a component change for the target compute node to achieve the associated increase in performance.

19. The computer program product of claim 18, further comprising:
automatically implementing the recommended component change for the target compute node, wherein the recommended component change is selected from a change in firmware version, a change in driver version, and a change in a software application version.
